(19) United States
(12) Patent Application Publication
(10) Pub. No.: US 2025/0125423 A1
(43) Pub. Date: Apr. 17, 2025

(54) METHOD FOR MANUFACTURING SECONDARY BATTERY

(71) Applicant: HONDA MOTOR CO., LTD., Tokyo (JP)

(72) Inventors: Takeshi FUJINO, Saitama (JP); Nao YOSHINAGA, Saitama (JP)

(73) Assignee: HONDA MOTOR CO., LTD., Tokyo (JP)

(21) Appl. No.: 18/912,667

(22) Filed: Oct. 11, 2024

(30) Foreign Application Priority Data
Oct. 16, 2023 (JP) 2023-178247

(51) Int. Cl. H01M 10/058; H01M 4/02; H01M 4/38; H01M 10/052

(52) U.S. Cl. CPC H01M 10/058; H01M 4/382; H01M 10/052; H01M 2004/027

(57) ABSTRACT

A method for manufacturing a secondary battery including an electrode laminate obtained by laminating a positive electrode layer and a negative electrode layer, and an exterior body accommodating the electrode laminate, includes: forming or storing the positive electrode layer; forming or storing the negative electrode layer; and laminating the positive electrode layer and the negative electrode layer so that the positive electrode layer and the negative electrode layer are accommodated in the exterior body, and based on a dew point required in each of: the forming or storing of the positive electrode layer; the forming or storing of the negative electrode layer; and the laminating, a dehumidification gas delivered from a dehumidifier is circulated in an order from one, in which a lowest dew point is required, of: the forming or storing of the positive electrode layer; the forming or storing of the negative electrode layer; and the laminating.

### CROSS-REFERENCE TO RELATED APPLICATION

This application is based on and claims priority under 35 USC 119 from Japanese Patent Application No. 2023-178247 filed on Oct. 16, 2023.

### TECHNICAL FIELD

The present invention relates to a method for manufacturing a secondary battery.

### BACKGROUND ART

In recent years, researches and developments have been conducted on a secondary battery which contributes to improvement in energy efficiency in order to allow more people to have access to affordable, reliable, sustainable, and advanced energy.

When moisture is mixed in a material constituting a secondary battery, charge and discharge performance may be decreased, and thus it is necessary to control a dew point at the time of manufacturing the secondary battery. For example, KR10-2022-0046333A describes an air circulation system for manufacturing a secondary battery in which a clean booth for accommodating a secondary battery manufacturing device is provided inside a dry room, and an inside of the dry room is dehumidified by a dehumidification unit.

### SUMMARY OF INVENTION

In KR10-2022-0046333A, a dehumidifier is operated to maintain a constant low-humidity environment inside the dry room in which the secondary battery manufacturing device is provided, and thus power consumption of the dehumidifier is large, and there is room for improvement in terms of reducing the power consumption.

The present invention provides a method for manufacturing a secondary battery, which can reduce power consumption of a dehumidifier that forms a low-dew-point environment. This further contributes to improvement in energy efficiency.

The present invention is a method for manufacturing a secondary battery, the secondary battery including an electrode laminate obtained by laminating a positive electrode layer and a negative electrode layer, and an exterior body accommodating the electrode laminate, the method including:
a positive electrode step of forming or storing the positive electrode layer;
a negative electrode step of forming or storing the negative electrode layer; and
a battery assembly step of laminating the positive electrode layer and the negative electrode layer and accommodating the positive electrode layer and the negative electrode layer in the exterior body, in which
based on a dew point required in each step, a dehumidification gas delivered from a dehumidifier is circulated in an order from a step having a lowest dew point.

The present invention is a method for manufacturing a secondary battery, the secondary battery including an electrode laminate obtained by laminating a positive electrode layer and a negative electrode layer, and an exterior body accommodating the electrode laminate, the method including:
a positive electrode step of forming or storing the positive electrode layer;
a negative electrode step of forming or storing the negative electrode layer;
a laminate forming step of forming the electrode laminate by laminating the positive electrode layer and the negative electrode layer, and accommodating the electrode laminate in the exterior body;
a liquid injection step of injecting an electrolyte into an interior of the exterior body; and
a drying step of introducing, into a dry box, a dehumidification gas delivered from a dehumidifier, and drying, in the dry box, the electrode laminate accommodated in the exterior body, before the liquid injection step.

According to the present invention, power consumption of a dehumidifier that forms a low-dew-point environment can be reduced.

### BRIEF DESCRIPTION OF DRAWINGS

FIG. 1 is an external perspective view of a secondary battery 10 according to an embodiment of the present invention.

FIG. 2 is a schematic cross-sectional view of the secondary battery 10.

FIG. 3 is a block diagram illustrating a method for manufacturing the secondary battery 10.

FIGS. 4A, 4B and 4C are schematic diagrams illustrating a drying step S122, conveyance from the drying step S122 to a liquid injection step S123, and the liquid injection step S123 in a dry box 80, respectively.

### DESCRIPTION OF EMBODIMENTS

First, a secondary battery according to an embodiment of the present invention will be described.

### —Secondary Battery—

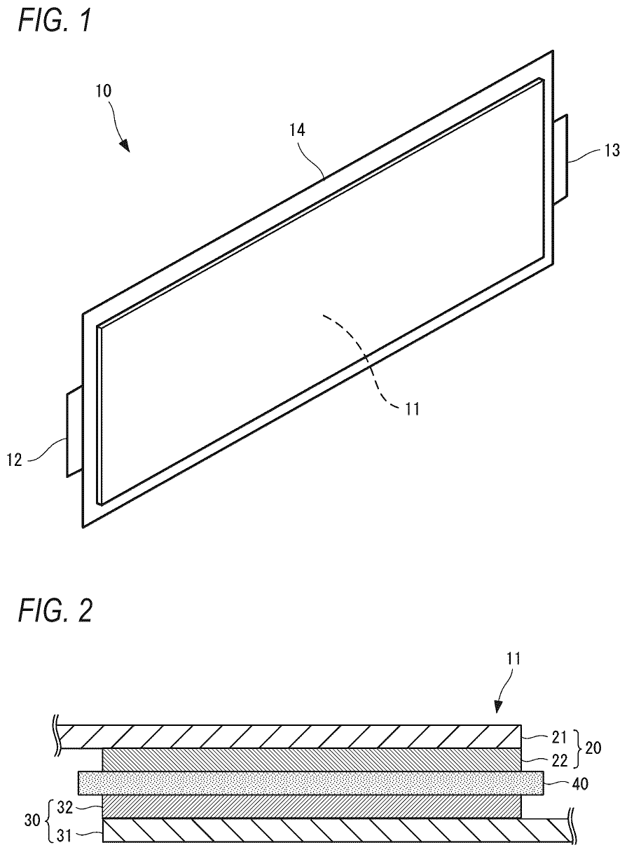

FIG. 1 is an external perspective view of a secondary battery 10, and FIG. 2 is a schematic cross-sectional view of the secondary battery 10.

The secondary battery 10 includes an electrode laminate 11, a positive electrode tab lead 12 and a negative electrode tab lead 13 extending from both ends of the electrode laminate 11, and an exterior body 14 (for example, a laminate film) accommodating the electrode laminate 11. The electrode laminate 11 includes a positive electrode layer 20 to which the positive electrode tab lead 12 is welded, a negative electrode layer 30 to which the negative electrode tab lead 13 is welded, and a separator 40 disposed between the positive electrode layer 20 and the negative electrode layer 30. In an example shown in FIG. 2, the electrode laminate 11 includes only one positive electrode layer 20, one separator 40, and one negative electrode layer 30, and may be implemented by laminating a plurality of positive electrode layers 20, separators 40, and negative electrode layers 30.

The secondary battery 10 is implemented by sealing the positive electrode layer 20, the negative electrode layer 30, and the separator 40 together with an electrolytic solution in an interior of the exterior body 14 while the positive electrode layer 20, the negative electrode layer 30, and the separator 40 are laminated, and performs charging and discharging by transferring lithium ions between the positive electrode layer 20 and the negative electrode layer 30 via the electrolytic solution.

The positive electrode layer 20 includes a positive-electrode current collector layer 21 and a positive electrode active material layer 22 laminated on each other.

The positive-electrode current collector layer 21 preferably includes at least one substance having a high conductivity. Examples of the substance having a high conductivity include metals or alloys containing at least one metal element of silver, palladium, gold, platinum, aluminum, copper, chromium, and nickel, or non-metals such as carbon. Considering the manufacturing cost in addition to the high conductivity, aluminum, nickel, or stainless steel is preferred.

Examples of a shape of the positive-electrode current collector layer 21 include a foil shape, a plate shape, a mesh shape, a nonwoven fabric shape, and a foam shape. In order to increase adhesion with the positive electrode active material layer 22, carbon or the like may be disposed on a surface of the positive-electrode current collector layer 21, or the surface may be roughened.

The positive electrode active material layer 22 contains a positive electrode active material that transfers lithium ions and electrons. The positive electrode active material is not particularly limited as long as the material can reversibly release and absorb lithium ions and can transport electrons. Examples of the positive electrode active material include a lithium composite oxide such as a lithium cobalt oxide (LiCoO₂) and a lithium-manganese-nickel-cobalt oxide. The positive electrode active material layer 22 may be made of one type of material, or two or more types of materials. The positive electrode active material layer 22 may further contain a conductive assistance, a binder, or the like.

The negative electrode layer 30 includes a negative-electrode current collector layer 31 and a negative electrode active material layer 32 laminated on each other.

Similarly to the positive-electrode current collector layer 21, the negative-electrode current collector layer 31 preferably includes at least one substance having a high conductivity, and examples thereof include metals or alloys containing at least one metal element of silver, palladium, gold, platinum, aluminum, copper, chromium, and nickel, or non-metals such as carbon.

Examples of a shape of the negative-electrode current collector layer 31 include a foil shape, a plate shape, a mesh shape, a nonwoven fabric shape, and a foam shape. In order to increase adhesion with the negative electrode active material layer 32, carbon or the like may be disposed on a surface of the negative-electrode current collector layer 31, or the surface may be roughened.

The negative electrode active material layer 32 contains a negative electrode active material that transfers lithium ions and electrons. The negative electrode active material is not particularly limited as long as the material can reversibly release and absorb lithium ions and can transport electrons. Examples of the negative electrode active material include metallic lithium, lithium alloys, metal oxides, metal sulfides, metal nitrides, Si, SiO, and carbon materials (such as graphite, hard carbon, and soft carbon). The negative electrode active material may be made of one type of material, or two or more types of materials. The negative electrode active material layer 32 may further contain a conductive assistance, a binder, or the like.

The separator 40 is an insulator made of, for example, a nonwoven fabric of glass fibers or a porous resin film, and is impregnated with the electrolytic solution. The separator 40 is interposed between the positive electrode layer 20 and the negative electrode layer 30, thereby avoiding occurrence of a short circuit between the positive electrode layer 20 and the negative electrode layer 30. A material forming the separator 40 is not particularly limited, and examples thereof include polyolefins such as polyethylene and polypropylene, aramid, polyimide, fluororesin, glass fiber, and cellulose fiber. In particular, in the separator 40 including an inorganic particle layer thereon, it is necessary to dry and remove moisture re-adsorbed on surfaces of inorganic particulates, which is effective in combination with a method for manufacturing a secondary battery of the present invention to be described later.

The electrolytic solution is, for example, an organic electrolytic solution in which an electrolyte is dissolved in an organic solvent. The organic solvent may be a cyclic carbonate, a chain carbonate, a cyclic ether, a chain ether, a hydrofluoro ether, an aromatic ether, a sulfone, a cyclic ester, a chain carboxylic acid ester, or a nitrile, and examples thereof include propylene carbonate, ethylene carbonate, diethyl carbonate, ethyl methyl carbonate, and diethylene glycol dimethyl ether. Examples of the cyclic ether include tetrahydrofuran, 2-methyltetrahydrofuran, tetrahydropyran, 1,3-dioxolane, and 4-methyl 1,3-dioxolane. Examples of the chain ether include 1,2-dimethoxyethane, 1,2-diethoxyethane, ethoxymethoxyethane, and diethyl ether. Examples of the hydrofluoro ether include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane. These organic solvents may be used alone or two or more thereof may be used in combination. Examples of the electrolyte include lithium hexafluorophosphate, lithium tetrafluoroborate, lithium perchlorate, lithium bis(fluorosulfonyl)imide, and lithium bis(trifluoromethanesulfonyl)imide. These electrolytes may be used alone or two or more thereof may be used in combination.

### —Method for Manufacturing Secondary Battery—

Next, regarding a method for manufacturing a secondary battery according to an embodiment of the present invention, first, an overview of the manufacturing method will be described, and then, dew point control at the time of manufacturing will be described.

### (Overview of Manufacturing Method)

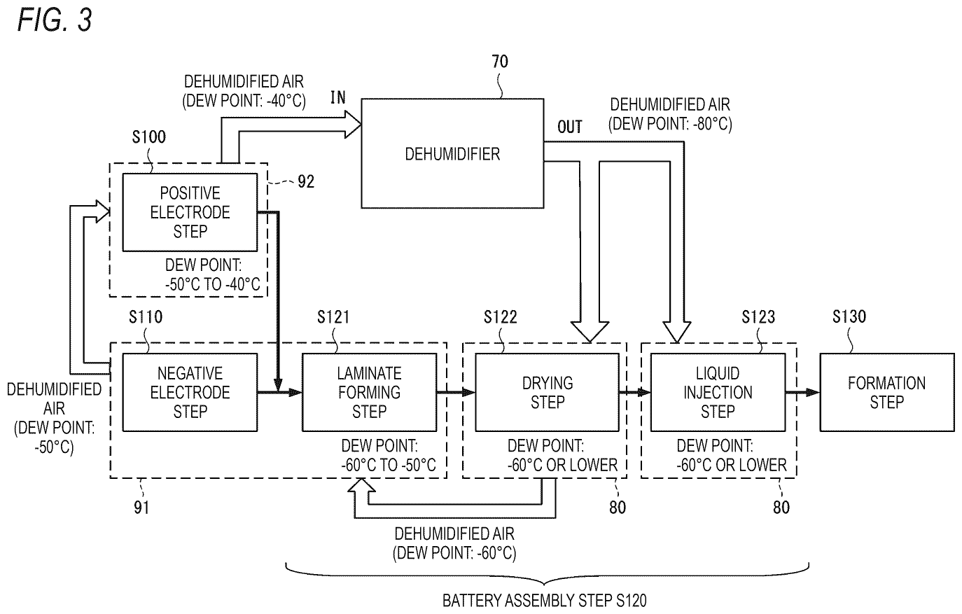

FIG. 3 is a block diagram illustrating the method for manufacturing the secondary battery. The method for manufacturing the secondary battery 10 of the present embodiment includes a positive electrode step S100 of forming or storing the positive electrode layer 20, a negative electrode step S110 of forming or storing the negative electrode layer 30, a battery assembly step S120 of laminating the positive electrode layer 20 and the negative electrode layer 30 and accommodating the positive electrode layer 20 and the negative electrode layer 30 in the exterior body 14, and a formation step S130 of subjecting the secondary battery 10 to formation.

The positive electrode step S100 includes, for example, a coating step of coating the positive-electrode current collector layer 21 with the positive electrode active material to form the positive electrode active material layer 22, a pressing step of pressing the laminated positive-electrode current collector layer 21 and positive electrode active material layer 22 by a roll pressing machine or the like to form the positive electrode layer 20, and a slit step of cutting the positive electrode layer 20 after the pressing step to a predetermined dimension. The positive electrode step S100 may include a storage step of storing (including temporary storage) the positive electrode layer 20 after forming the positive electrode layer 20 and before the battery assembly step S120, or storing the procured positive electrode layer 20 when the positive electrode layer 20 is separately procured without providing a step of forming the positive electrode layer 20 in a production line.

Similarly to the positive electrode step S100, the negative electrode step S110 also includes, for example, a coating step of coating the negative-electrode current collector layer 31 with the negative electrode active material to form the negative electrode active material layer 32, a pressing step of pressing the laminated negative-electrode current collector layer 31 and negative electrode active material layer 32 by a roll pressing machine or the like to form the negative electrode layer 30, and a slit step of cutting the negative electrode layer 30 after the pressing step to a predetermined dimension. The negative electrode step S110 may include a storage step of storing (including temporary storage) the negative electrode layer 30 after forming the negative electrode layer 30 and before the battery assembly step S120, or storing the procured negative electrode layer 30 when the negative electrode layer 30 is separately procured without providing a step of forming the negative electrode layer 30 in a production line.

The battery assembly step S120 includes a laminate forming step S121 of forming the electrode laminate 11 by laminating the positive electrode layer 20 and the negative electrode layer 30 and accommodating the electrode laminate 11 in the exterior body 14, a drying step S122 of drying the electrode laminate 11 accommodated in the exterior body 14, and a liquid injection step S123 of injecting the electrolytic solution into the interior of the exterior body 14.

The laminate forming step S121 includes, for example, an electrode laminating step of laminating the positive electrode layer 20 and the negative electrode layer 30 with the separator 40 interposed therebetween to form the electrode laminate 11, a tab welding step of welding the positive electrode tab lead 12 and the negative electrode tab lead 13 to the positive electrode layer 20 and the negative electrode layer 30, respectively, and an accommodating step of accommodating the electrode laminate 11 in the exterior body 14.

The drying step S122 is a step of drying the electrode laminate 11 accommodated in the exterior body 14 in an environment having an extremely low dew point before the liquid injection step S123 is performed. Although details will be described later, in the drying step S122, the electrode laminate 11 is dried by waiting for a predetermined time in the dry box 80 into which dehumidified air delivered from the dehumidifier 70 is introduced. An interior of the dry box 80 does not include devices or equipment groups such as a laminating device, a welding device, and a laminate seal, and thus it is possible to minimize the interior of the dry box 80, and since a gas replacement speed is high, it is possible to dry the electrode laminate 11 in a short residence time. A temperature of the dehumidified air in the dry box 80 is preferably higher than room temperature, and a drying time is shortened by passing the dehumidified air at, for example, 30° C. to 80° C. In addition, it is also possible to further shorten the drying time by flowing a low-moisture gas such as dry nitrogen or argon into the dry box 80 in addition to the dehumidified air.

In the liquid injection step S123, the electrolytic solution is injected into the interior of the exterior body 14 under an environment having an extremely low dew point, and the exterior body 14 is sealed. In the present embodiment, the liquid injection step S123 is also performed in the dry box 80, similar to the drying step S122. Since the electrode laminate 11 is dried in the drying step S122 before the liquid injection step S123, it is possible to prevent mixing of moisture into the electrolytic solution. After the injection, an opening of the exterior body 14 is temporarily sealed by thermal welding.

The formation step S130 includes, for example, an aging step of standing for a predetermined time while charging. After the formation step S130, the temporarily sealed opening of the exterior body 14 is sealed again.

### (Dew Point Control)

When moisture is mixed in a material constituting the secondary battery 10 at the time of manufacturing the secondary battery 10, charge and discharge performance of the secondary battery 10 may be decreased, and thus it is necessary to control a dew point in each step included in a production line of the secondary battery 10. Here, the dew point substantially indicates a degree of drying of a space, and the lower the dew point, the higher the degree of drying of the space, and the higher the dew point, the lower the degree of drying of the space.

For example, when a lithium ion battery using graphite as the negative electrode active material is manufactured, the entire manufacturing step is generally formed in an environment having a low dew point (for example, a dew point of −40° C. or lower). When a lithium metal secondary battery using lithium metal as the negative electrode active material is manufactured, since lithium metal has high reactivity with moisture due to a high ionization tendency, an environment having a lower dew point (for example, a dew point of −50° C. or lower) is required in a step in which the negative electrode layer 30 is exposed in the manufacturing step.

The environment having a dew point (hereinafter, also referred to as a low-dew-point environment) is formed by supplying and exhausting, to the production line of the secondary battery 10, the dehumidified air generated by the dehumidifier 70 being dehumidified to a low dew point. The production line is an environment in which moisture may be normally generated by a worker working in each step, and thus the dehumidifier 70 continuously supplies the dehumidified air. The dehumidifier 70 can adjust a volume of the dehumidified air (amount of the dehumidified air passing through per unit time), and adjust a dew point of the dehumidified air supplied to the production line by adjusting the volume. In the manufacture of the secondary battery 10, power consumption due to an operation of the dehumidifier 70 is large.

In order to realize a uniform low-dew-point environment in the entire production line, it is necessary to increase the volume of the dehumidified air delivered from the dehumidifier because a space volume of a supply destination of the dehumidified air is large, and the power consumption of the dehumidifier is further increased. Further, equipment investment such as an increase in the number of installed dehumidifiers is also required, and accordingly, the power consumption due to operations of a plurality of dehumidifiers is further increased. Accordingly, the manufacturing cost of the secondary battery 10 is increased.

Therefore, in the method for manufacturing the secondary battery 10 of the present embodiment, based on a dew point required in each step, the dehumidified air delivered from the dehumidifier 70 is circulated in an order from a step having a lowest required dew point. Accordingly, it is not necessary to form all the steps in a uniform low-dew-point environment in accordance with the step requiring the lowest dew point, and thus the power consumption due to the operation of the dehumidifier 70 can be reduced. In addition, an increase in equipment investment of the dehumidifier 70 can be prevented. Thus, the manufacturing cost of the secondary battery 10 can be reduced.

Hereinafter, the dew point control described above will be described more specifically. In the following description, a case where the secondary battery 10 is a lithium metal secondary battery having a high energy density will be described as an example, and a specific value of the dew point will be described as an example.

Since the lithium metal secondary battery contains lithium metal having high reactivity with moisture in the negative electrode active material, the dew point is strictly controlled such that the negative electrode step S110 has a low-dew-point environment. The positive electrode step S100 does not need to be controlled to a low dew point as low as the negative electrode step S110, and is controlled to a dew point higher than that of the negative electrode step S110. The battery assembly step S120 is a step downstream of the manufacturing step of the secondary battery 10, and the dew point is more strictly controlled so as to have a dew point lower than that of the negative electrode step S110 such that moisture is not mixed immediately before the assembling of the secondary battery 10 is completed. That is, a required dew point is lower in an order of the battery assembly step S120, the negative electrode step S110 and the positive electrode step S100 (thus, the required dew point is lowest in the battery assembly step S120 among these three steps and is highest in the positive electrode step S100 among these three steps.).

Therefore, the dehumidifier 70 circulates the dehumidified air in an order of the battery assembly step S120, the negative electrode step S110, and the positive electrode step S100. At this time, a dew point of the dehumidified air is the lowest in the battery assembly step S120, which is closer to the dehumidifier 70, and gradually increases in an order of the negative electrode step S110 and the positive electrode step S100. By circulating the dehumidified air in this order, it is possible to satisfy the dew point required in each step without making all the steps a uniform low-dew-point environment, and thus it is possible to reduce the power consumption due to the operation of the dehumidifier 70.

More specifically, the dehumidifier 70 circulates the dehumidified air from the drying step S122 and the liquid injection step S123 in the manufacturing step. In other words, the dehumidifier 70 first supplies the dehumidified air to the dry box 80.

The production line of the secondary battery 10 is provided with a plurality of pipes (not shown) through which the dehumidified air delivered from the dehumidifier 70 flows. The plurality of pipes are provided between an air outlet of the dehumidifier 70 and the dry box 80 (that is, a space in which the drying step S122 and the liquid injection step S123 are performed), between the dry box 80 and a space 91 in which the negative electrode step S110 and the laminate forming step S121 are performed, between the space 91 and a space 92 in which the positive electrode step S100 is performed, and between the space 92 and an air intake of the dehumidifier 70.

The dew point of the dehumidified air generated by the dehumidifier 70 is, for example, −80° C., and a moisture content of the dehumidified air is 1 ppm or less. When the dehumidified air is supplied to the dry box 80, the dry box 80 has a dew point of, for example, −60° C. or lower, which is an environment having an extremely low dew point. Accordingly, the dew point required in the drying step S122 and the liquid injection step S123 is satisfied.

The dew point of the dehumidified air exhausted from the dry box 80 and supplied to the space 91 in which the negative electrode step S110 and the laminate forming step S121 are performed is about the same as the dew point in the dry box 80, and is, for example, −60° C. When the dehumidified air is supplied to the space 91, a dew point of the space 91 becomes, for example, −60° C. to −50° C. Although the space 91 has a higher dew point than the dry box 80, the negative electrode step S110 and the laminate forming step S121 in which the negative electrode layer 30 is exposed (that is, the negative electrode layer 30 is not sealed by the exterior body 14) are performed, and thus the low-dew-point environment is required. Accordingly, the dew point required in the negative electrode step S110 and the laminate forming step S121 is satisfied.

The dew point of the dehumidified air exhausted from the space 91 and introduced into the space 92 in which the positive electrode step S100 is performed is about the same as the dew point of the space 91, and is, for example, −50° C. When the dehumidified air is supplied to the space 92, a dew point of the space 92 becomes, for example, −50° C. to −40° C. Accordingly, the dew point required in the positive electrode step S100 is satisfied.

The dehumidified air (for example, having the dew point of −40° C.) exhausted from the space 92 is introduced into the dehumidifier 70, is dehumidified until the dew point reaches −80° C., and is then supplied to the dry box 80 again. The dehumidifier 70 circulates the dehumidified air in a direction from downstream to upstream of the production line of the secondary battery 10.

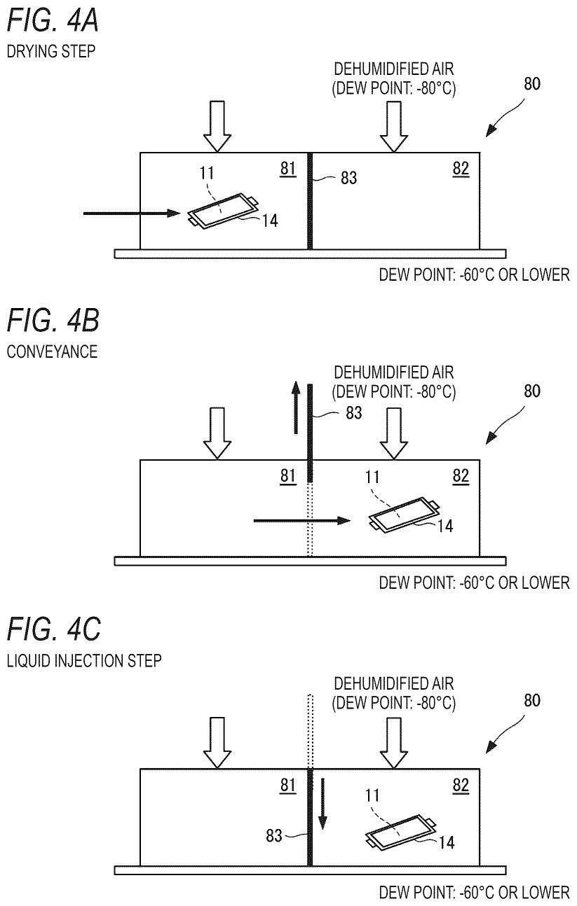

FIGS. 4A, 4B and 4C are schematic diagrams illustrating the dry box 80. The dry box 80 is a local space that does not allow people to enter or exit, and prevents moisture generated by a human body from mixing with the electrode laminate 11.

The dry box 80 has a first space 81 and a second space 82 which are partitioned by an openable and closable shutter 83. The second space 82 is located downstream of the first space 81 in the production line. Although the first space 81 and the second space 82 are partitioned by the shutter 83, the dehumidified air is introduced from the dehumidifier 70 into each space, and dew points of the first space 81 and the second space 82 are substantially the same.

After the laminate forming step S121, the electrode laminate 11 accommodated in the exterior body 14 is conveyed to the first space 81, and the drying step S122 is performed in the first space 81 (FIG. 4A). In the drying step S122, the dew point and a drying time of the first space 81 are controlled so as to remove moisture contained in the electrode laminate 11 as much as possible before the liquid injection step S123.

The dew point of the first space 81 is −60° C. or lower as described above, and the drying time is, for example, 1 minute or more and 72 hours or less. More specifically, the drying time is adjusted according to the dew point of the first space 81, for example, when the dew point of the first space 81 is −70° C., the electrode laminate 11 can be sufficiently dried by setting the drying time to 3 hours. In the present embodiment, not only in the drying step S122, but also in the steps (the positive electrode step S100, the negative electrode step S110, and the laminate forming step S121) upstream of the drying step S122, the low-dew-point environment is formed by circulating the dehumidified air, and thus the drying time in the drying step S122 can be shortened, and the power consumption of the dehumidifier 70 can be reduced.

After the drying step S122, the shutter 83 is opened, and the electrode laminate 11 accommodated in the exterior body 14 is conveyed from the first space 81 to the second space 82 (FIG. 4B). After the electrode laminate 11 is conveyed to the second space 82, the shutter 83 is closed. Although not shown, after the electrode laminate 11 is conveyed from the first space 81 to the second space 82, a new electrode laminate 11 is conveyed to the first space 81, and the drying step S122 is performed on the electrode laminate 11.

In the second space 82, the liquid injection step S123 is performed (FIG. 4C). Similarly to the drying step S122, the liquid injection step S123 is also performed in an environment having an extremely low dew point. In this way, the drying step S122 and the liquid injection step S123 are continuously performed in the dry box 80.

When the secondary battery 10 is the lithium metal secondary battery, a water-insoluble organic electrolytic solution is injected into the interior of the exterior body 14. A moisture content of the electrolytic solution at this time is, for example, 50 ppm or less, and the electrolytic solution having an extremely low moisture content is injected.

After the liquid injection step S123, the exterior body 14 is temporarily sealed in the second space 82 by thermal welding or the like. Accordingly, the electrode laminate 11 and the electrolytic solution are sealed in the interior of the exterior body 14, and moisture does not penetrate into the electrode laminate 11 and the electrolytic solution, and thus the dew point control is unnecessary in the subsequent step (that is, the formation step S130).

The dew point control in the method for manufacturing the secondary battery 10 described above can be applied whether the secondary battery 10 is a liquid battery containing a liquid electrolyte, a semi-solid-state battery containing a semi-solid electrolyte, or an all-solid-state battery containing a solid electrolyte.

When the secondary battery 10 is a semi-solid-state battery, a semi-solid electrolyte is injected into the interior of the exterior body 14 in the liquid injection step S123 described above. Here, the semi-solid electrolyte is an electrolyte of a mixture of a liquid phase and a solid phase, such as a slurry, a particle suspension, a colloid suspension, an emulsion, a gel, and a micelle.

When the secondary battery 10 is an all-solid-state battery, the electrode laminate 11 of the secondary battery 10 includes a solid electrolyte layer or the like provided between the positive electrode layer 20 and the negative electrode layer 30, instead of the separator 40. The liquid injection step S123 described above is omitted, and the exterior body 14 is sealed after the drying step S122.

Although an embodiment of the present invention has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. In addition, the constituent elements in the above embodiments may be freely combined without departing from the gist of the invention.

For example, when the secondary battery 10 is a lithium metal secondary battery, a passivation layer containing lithium carbonate (Li₂CO₃) may be formed on a surface of the negative electrode layer 30 containing metal lithium. In this way, by forming a passivated layer on the surface of the negative electrode layer 30, it is possible to further prevent a reaction of metal lithium with moisture. When a surface of a lithium metal negative electrode is modified, the reaction with moisture can be reduced, and thus moisture is less likely to react with lithium, and is in an adsorbed state. Accordingly, the moisture can be removed more quickly. In such a case, a residence time of the electrode laminate 11 in the dry box 80 having a low dew point can be further shortened, and thus a manufacturing speed of the secondary battery 10 is further increased.

In the embodiment described above, the dew point control has been described using the case where the secondary battery 10 is a lithium metal secondary battery as an example, but the secondary battery 10 is not limited to the lithium metal secondary battery, and the dew point control can be applied to various types of batteries.

In the present specification, at least the following matters are described. In parentheses, the corresponding constituent elements and the like in the above embodiment are shown as an example, but the present invention is not limited thereto.
(1) A method for manufacturing a secondary battery (secondary battery 10), the secondary battery including an electrode laminate (electrode laminate 11) obtained by laminating a positive electrode layer (positive electrode layer 20) and a negative electrode layer (negative electrode layer 30), and an exterior body (exterior body 14) accommodating the electrode laminate, the method including:
a positive electrode step (positive electrode step S100) of forming or storing the positive electrode layer;
a negative electrode step (negative electrode step S110) of forming or storing the negative electrode layer; and
a battery assembly step (battery assembly step S120) of laminating the positive electrode layer and the negative electrode layer and accommodating the positive electrode layer and the negative electrode layer in the exterior body, in which based on a dew point required in each step, a dehumidification gas delivered from a dehumidifier (dehumidifier 70) is circulated in an order from a step having a lowest dew point.
According to (1), since the dehumidification gas is circulated in the order from the step having the lowest dew point based on the dew point required in each step, it is possible to reduce power consumption due to an operation of the dehumidifier as compared with a case where a uniform low-dew-point environment is realized in all the steps at the time of manufacturing the secondary battery. Thus, the manufacturing cost of the secondary battery can be reduced.
(2) The method for manufacturing a secondary battery according to (1), in which the dew point required in the battery assembly step is lower than the dew point required in the negative electrode step, and the dew point required in the negative electrode step is lower than the dew point required in the positive electrode step, and the dehumidification gas delivered from the dehumidifier is circulated in an order of the battery assembly step, the negative electrode step, and the positive electrode step.
According to (2), the dehumidification gas is circulated from the battery assembly step, which is closer to downstream of a manufacturing step, and thus it is possible to prevent mixing of moisture immediately before the completion of the secondary battery. In addition, the dehumidification gas is circulated preferentially through the negative electrode step in which the negative electrode layer having high reactivity with moisture is exposed and a low dew point is required, rather than through the positive electrode step, and thus it is possible to prevent mixing of moisture into the negative electrode layer.
(3) The method for manufacturing a secondary battery according to (2), in which
the battery assembly step includes
a laminate forming step (laminate forming step S121) of forming the electrode laminate by laminating the positive electrode layer and the negative electrode layer, and accommodating the electrode laminate in the exterior body, and
a drying step (drying step S122) of drying, in a dry box (dry box 80), the electrode laminate accommodated in the exterior body,
the drying step is required to have a lowest dew point, and
the dehumidification gas delivered from the dehumidifier is circulated from the drying step.
According to (3), the electrode laminate is locally dried in the dry box in the drying step, which is closer to the downstream of the manufacturing step, and thus it is possible to more reliably prevent mixing of moisture into the electrode laminate. In addition, since the dew point gradually decreases toward the downstream of the manufacturing step, a drying time in the drying step can be shortened, and the power consumption of the dehumidifier can be further reduced.
(4) The method for manufacturing a secondary battery according to (3), in which
the battery assembly step further includes a liquid injection step (liquid injection step S123) of injecting an electrolyte into an interior of the exterior body after the drying step, and
the liquid injection step is performed in the dry box.
According to (4), since the drying step is performed before the liquid injection step, it is possible to prevent mixing of moisture into the electrolyte.
(5) The method for manufacturing a secondary battery according to (4), in which
the dry box includes a first space (first space 81) and a second space (second space 82) which are partitioned by an openable and closable opening and closing member (shutter 83),
the drying step is performed in the first space with the opening and closing member closed,
the opening and closing member is opened after the drying step, the electrode laminate accommodated in the exterior body is conveyed from the first space to the second space, and
the liquid injection step is performed in the second space with the opening and closing member closed.
According to (5), the drying step and the liquid injection step can be continuously performed in the dry box.
(6) The method for manufacturing a secondary battery according to (4) or (5), in which
a moisture content of the electrolyte to be injected into the interior of the exterior body in the liquid injection step is 50 ppm or less.
According to (6), the electrolyte having an extremely low moisture content is injected into the interior of the exterior body in the liquid injection step.
(7) The method for manufacturing a secondary battery according to any one of (3) to (6), in which
in the drying step, the electrode laminate accommodated in the exterior body is dried at a predetermined dew point for a predetermined time.
According to (7), by controlling the dew point and the drying time in the drying step, it is possible to more reliably prevent the mixing of the moisture into the electrode laminate.
(8) The method for manufacturing a secondary battery according to (7), in which
the predetermined dew point is −60° C. or lower.
According to (8), the electrode laminate is locally dried in an environment having an extremely low dew point, and thus it is possible to more reliably prevent the mixing of the moisture into the electrode laminate, and the adsorbed moisture is desorbed in a short time.
(9) The method for manufacturing a secondary battery according to (7) or (8), in which
the predetermined time is 1 minute or more and 72 hours or less.
According to (9), the drying step is performed for a short time, and thus the power consumption of the dehumidifier can be significantly reduced.
(10) The method for manufacturing a secondary battery according to any one of (3) to (9), in which
the dehumidification gas to be introduced into the dry box has a moisture content of 1 ppm or less.
According to (10), the electrode laminate is locally dried in an environment having an extremely low dew point, and thus it is possible to more reliably prevent the mixing of the moisture into the electrode laminate.
(11) The method for manufacturing a secondary battery according to any one of (3) to (10), in which
the dry box is a space that does not allow people to enter or exit.
According to (11), moisture generated by a human body can be prevented from entering the dry box, and an interior of the dry box can be kept in an environment having an extremely low dew point.
(12) The method for manufacturing a secondary battery according to any one of (1) to (11), in which
the secondary battery is a lithium metal secondary battery in which a negative electrode active material of the negative electrode layer contains lithium metal.
According to (12), even when the negative electrode active material contains lithium metal having high reactivity with moisture and an environment having an extremely low dew point is required, it is possible to reduce the power consumption and the number of installed dehumidifiers, and to reduce the manufacturing cost of the secondary battery.
(13) The method for manufacturing a secondary battery according to (12), in which
a passivation layer containing lithium carbonate is formed on a surface of the negative electrode layer.
According to (13), in the lithium metal secondary battery, a moisture reaction in the negative electrode layer can be prevented.
(14) A method for manufacturing a secondary battery (secondary battery 10), the secondary battery including an electrode laminate (electrode laminate 11) obtained by laminating a positive electrode layer (positive electrode layer 20) and a negative electrode layer (negative electrode layer 30), and an exterior body (exterior body 14) accommodating the electrode laminate, the method including:
a positive electrode step (positive electrode step S100) of forming or storing the positive electrode layer;
a negative electrode step (negative electrode step S110) of forming or storing the negative electrode layer;
a laminate forming step (laminate forming step S121) of forming the electrode laminate by laminating the positive electrode layer and the negative electrode layer, and accommodating the electrode laminate in the exterior body;
a liquid injection step (liquid injection step S123) of injecting an electrolyte into an interior of the exterior body; and
a drying step (drying step S122) of introducing, into a dry box (dry box 80), a dehumidification gas delivered from a dehumidifier (dehumidifier 70), and drying, in the dry box, the electrode laminate accommodated in the exterior body, before the liquid injection step.
According to (14), the electrode laminate is locally dried in the dry box in the drying step, which is closer to downstream of a manufacturing step, and thus it is possible to more reliably prevent mixing of moisture into the electrode laminate. In addition, since the drying step is performed before the liquid injection step, it is possible to prevent mixing of moisture into the electrolyte.

### REFERENCE SIGNS LIST

10: secondary battery
11: electrode laminate
14: exterior body
20: positive electrode layer
30: negative electrode layer
70: dehumidifier
80: dry box
81: first space
82: second space
83: shutter (opening and closing member)
S100: positive electrode step
S110: negative electrode step
S120: battery assembly step
S121: laminate forming step
S122: drying step
S123: liquid injection step

What is claimed is:

1. A method for manufacturing a secondary battery, the secondary battery including an electrode laminate obtained by laminating a positive electrode layer and a negative electrode layer, and an exterior body accommodating the electrode laminate, the method comprising:
forming or storing the positive electrode layer;
forming or storing the negative electrode layer; and
laminating the positive electrode layer and the negative electrode layer so that the positive electrode layer and the negative electrode layer are accommodated in the exterior body, wherein
based on a dew point required in each of: the forming or storing of the positive electrode layer; the forming or storing of the negative electrode layer; and the laminating, a dehumidification gas delivered from a dehumidifier is circulated in an order from one, in which a lowest dew point is required, of: the forming or storing of the positive electrode layer; the forming or storing of the negative electrode layer; and the laminating.

2. The method for manufacturing a secondary battery according to claim 1, wherein
the dew point required in the laminating is lower than the dew point required in the forming or storing of the negative electrode layer, and the dew point required in the forming or storing of the negative electrode layer is lower than the dew point required in the forming or storing of the positive electrode layer, and
the dehumidification gas delivered from the dehumidifier is circulated in an order of the laminating, the forming or storing of the negative electrode layer, and the forming or storing of the positive electrode layer.

3. The method for manufacturing a secondary battery according to claim 2, wherein
the laminating comprises:
forming the electrode laminate by laminating the positive electrode layer and the negative electrode layer, and accommodating the electrode laminate in the exterior body; and
drying, in a dry box, the electrode laminate accommodated in the exterior body,
the drying is a step required to have a lowest dew point, and
the dehumidification gas delivered from the dehumidifier is circulated from the drying.

4. The method for manufacturing a secondary battery according to claim 3, wherein
the laminating further comprises, after the drying, injecting an electrolyte into an interior of the exterior body, and
the injecting is performed in the dry box.

5. The method for manufacturing a secondary battery according to claim 4, wherein
the dry box has a first space and a second space which are partitioned by an opening and closing member which is openable and closable,
the drying is performed in the first space with the opening and closing member closed,
after the drying, the opening and closing member is opened and the electrode laminate accommodated in the exterior body is conveyed from the first space to the second space, and
the injecting is performed in the second space with the opening and closing member closed.

6. The method for manufacturing a secondary battery according to claim 4, wherein
a moisture content of the electrolyte to be injected into the interior of the exterior body in the injecting is 50 ppm or less.

7. The method for manufacturing a secondary battery according to claim 3, wherein
in the drying, the electrode laminate accommodated in the exterior body is dried at a predetermined dew point for a predetermined time.

8. The method for manufacturing a secondary battery according to claim 7, wherein
the predetermined dew point is −60° C. or lower.

9. The method for manufacturing a secondary battery according to claim 7, wherein
the predetermined time is 1 minute or more and 72 hours or less.

10. The method for manufacturing a secondary battery according to claim 3, wherein
the dehumidification gas to be introduced into the dry box has a moisture content of 1 ppm or less.

11. The method for manufacturing a secondary battery according to claim 3, wherein
the dry box is a space that does not allow people to enter or exit.

12. The method for manufacturing a secondary battery according to claim 1, wherein
the secondary battery is a lithium metal secondary battery in which a negative electrode active material of the negative electrode layer contains lithium metal.

13. The method for manufacturing a secondary battery according to claim 12, wherein
a passivation layer containing lithium carbonate is formed on a surface of the negative electrode layer.

14. A method for manufacturing a secondary battery, the secondary battery including an electrode laminate obtained by laminating a positive electrode layer and a negative electrode layer, and an exterior body accommodating the electrode laminate, the method comprising:
forming or storing the positive electrode layer;
forming or storing the negative electrode layer;
forming the electrode laminate by laminating the positive electrode layer and the negative electrode layer, and accommodating the electrode laminate in the exterior body;
injecting an electrolyte into an interior of the exterior body; and
before the injecting, introducing, into a dry box, a dehumidification gas delivered from a dehumidifier, and drying, in the dry box, the electrode laminate accommodated in the exterior body.
